(19) United States
(12) Patent Application Publication
(10) Pub. No.: US 2014/0004007 A1
(43) Pub. Date: Jan. 2, 2014

(54) SENSOR FOR MEASURING SOF OF DIESEL VEHICLE

(71) Applicant: HYUNDAI MOTOR COMPANY, Seoul (KR)

(72) Inventor: Cheol Beom Lim, Hwaseong-si (KR)

(73) Assignee: Hyundai Motor Company, Seoul (KR)

(21) Appl. No.: 13/683,701

(22) Filed: Nov. 21, 2012

(30) Foreign Application Priority Data
Jun. 29, 2012 (KR) 10-2012-0071124

(51) Int. Cl. G01N 25/28

(52) U.S. Cl. CPC G01N 25/28
USPC 422/94

(57) ABSTRACT

A sensor device for measuring SOF (Soluble Organic Fraction) of a diesel engine, may include an exothermic catalyst including a TiO₂ support impregnated with platinum (Pt) and causing a combustion reaction of the SOF to generate heat, a comparative catalyst including a TiO₂ support and not causing a combustion reaction of the SOF, and a measuring unit determining a discharge amount of the SOF using a temperature difference between the exothermic catalyst and the comparative catalyst.

### CROSS-REFERENCE TO RELATED APPLICATION

The present application claims priority to Korean Patent Application No. 10-2012-0071124, filed on Jun. 29, 2012, the entire contents of which is incorporated herein for all purposes by this reference.

### BACKGROUND OF THE INVENTION

1. Field of the Invention

The present invention relates generally to a sensor for measuring SOF of a diesel engine using a catalyst that has high combustion activity for SOF discharged from a diesel engine.

2. Description of Related Art

Generally, since a diesel oxidation catalyst (DOC) system is basically similar to oxidation catalyst technology which was being used in gasoline engines before ternary catalysts were developed, its technical effect and performance have already been assured. An oxidation catalyst, such as platinum (Pt), palladium (Pd) or the like, functions to remove hydrocarbons, carbon monoxide and the like form exhaust gas using oxygen in the air. Particularly, in diesel engines, the discharge of hydrocarbons and carbon monoxide is little problematic, but when hydrocarbons constituting the particular matter are reduced, the particulate matter can be reduced by 10˜20%.

That is, the DOC system is a technology which can most effectively remove the SOF (soluble organic fraction) from PM (particulate matter). SOF is a basic hydrocarbon component, and its discharge amount greatly depends on the operating conditions of an engine. Therefore, in order to efficiently operate an engine and DOC system, it is required to a technology which can detect the discharge amount of SOF in real time. However, SOF sensing technologies which can be mounted in vehicles have not yet been developed. Therefore, the development of a novel-concept contact-combustion type SOF sensor is being required. In order to realize the contact-combustion type SOF sensor, it is necessary to develop a catalyst having high selectivity and combustion activity for SOF.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a sensor for measuring the SOF of a diesel engine using a catalyst having a high combustion activity for SOF in the PM of exhaust gas discharged from a diesel engine.

In an aspect of the present invention, a sensor device for measuring SOF (Soluble Organic Fraction) of a diesel engine, may include an exothermic catalyst including a TiO₂ support impregnated with platinum (Pt) and causing a combustion reaction of the SOF to generate heat, a comparative catalyst including a TiO₂ support and not causing a combustion reaction of the SOF, and a measuring unit determining a discharge amount of the SOF using a temperature difference between the exothermic catalyst and the comparative catalyst.

In the exothermic catalyst, the TiO₂ support may include the platinum (Pt) in an amount of between 1 wt % and 7 wt %.

The exothermic catalyst is prepared by an impregnation process, a drying process and a heat treatment process.

In the impregnation process, the TiO₂ support in the exothermic catalyst is immersed into an aqueous Pt(NH₃)₂(NO₂)₂ precursor solution to support the TiO₂ support with the platinum (Pt).

The drying process is performed at between 60° C. and 100° C. for between 6 hours and 20 hours after the impregnation process.

The heat treatment process is performed at between 500° C. and 700° C. for between 2 hours and 5 hours after the drying process.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing a sensor for measuring SOF of a diesel engine according to an exemplary embodiment of the present invention.

FIG. 2 is a flowchart showing a process of preparing an exothermic catalyst of the sensor for measuring SOF of a diesel engine shown in FIG. 1.

FIG. 3 is a graph showing the discharge amount of SOF measured using the temperature difference between an exothermic catalyst and a comparative catalyst of the sensor for measuring SOF of a diesel engine shown in FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, preferred embodiments of the present invention will be described in detail with reference to the attached drawings.

FIG. is a schematic view showing a sensor for measuring SOF of a diesel engine according to an exemplary embodiment of the present invention. The sensor for measuring SOF of a diesel engine according to an exemplary embodiment of the present invention includes: an exothermic catalyst 100 including a TiO₂ support impregnated with platinum (Pt) and causing a combustion reaction of SOF (soluble organic fraction) to generate heat, a comparative catalyst 200 including a TiO₂ support and not causing a combustion reaction of SOF, and a measuring unit 300 calculating a discharge amount of SOF in exhaust gas using the temperature difference between the exothermic catalyst 100 and the comparative catalyst 200.

The present invention provides a sensor for measuring SOF using a catalyst having high combustion activity for SOF, that is, a sensor which can actively calculate the amount of SOF in PM of exhaust gas discharged from a diesel engine in real time.

That is, the sensor for measuring SOF of a diesel engine includes an exothermic catalyst 100 composed of a material having high combustion activity for SOF and a comparative catalyst 200 composed of a material having no combustion activity for SOF. This sensor measures the temperature difference between the exothermic catalyst 100 and the comparative catalyst 200 and the amount of heat generated at the time of the exothermic reaction between the exothermic catalyst 100 and the SOF, thus calculating the discharge amount of SOF.

Here, the exothermic catalyst 100 uses platinum (Pt), which selectively causes a combustion reaction of SOF and easily causes a catalytic reaction, as a carrier metal, and uses TiO₂, which hardly causes a combustion reaction of SOF and does not cause a catalytic reaction, as a support. Meanwhile, the comparative catalyst 200 is a comparative means for measuring the combustion heat generated by the combustion reaction of the exothermic catalyst 100 with SOF, and includes TiO₂ which does not cause a combustion reaction of SOF.

As described above, when the support of the exothermic catalyst 100 and the material of the comparative catalyst 200 include TiO₂, the combustion heat generated by the combustion reaction of SOF can be quantified, thus accurately measuring the temperature difference between the exothermic catalyst 100 and the comparative catalyst 200 attributable to the heat of combustion.

Therefore, the discharge amount of SOF can be actively measured using the temperature change and difference between the exothermic catalyst 100 supported with platinum (Pt) having high combustion activity for SOF and the comparative catalyst 200 composed of TiO₂ which does not cause a combustion reaction.

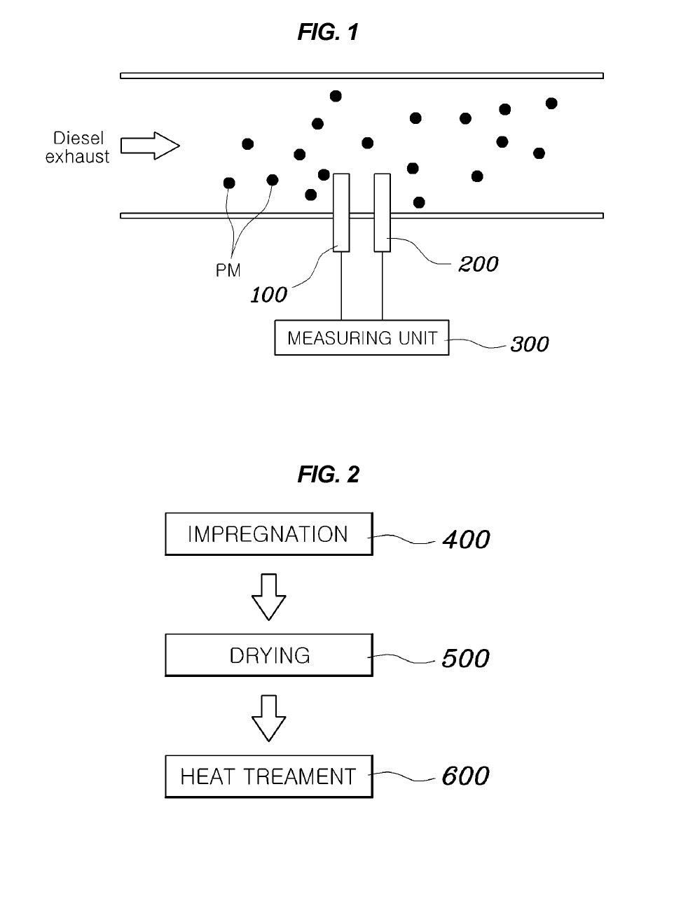

FIG. 2 is a flowchart showing a process of preparing the exothermic catalyst 100 of the sensor for measuring SOF of a diesel engine shown in FIG. 1. In the exothermic catalyst 100, TiO₂ may include platinum (Pt) in an amount of 1˜7 wt %. Like this, since TiO₂ includes platinum (Pt), the combustion reaction of the exothermic catalyst with SOF is caused, thus generating heat.

Of course, it is possible to rapidly cause a combustion reaction when the amount of platinum (Pt) is more than 7 wt %. However, the combustion reaction rate does not increase in proportion to the increment of platinum (Pt) even when the amount of platinum (Pt) is more than 7 wt %. Therefore, it is preferred that the amount of platinum (Pt) in TiO₂ be 1˜7 wt %. Here, when the amount of platinum (Pt) is 5 wt %, the optimum combustion reaction of SOF and the optimum catalytic activity for SOF are exhibited. Therefore, it is most preferred that TiO₂ be supported with 5 wt % of platinum (Pt).

As shown in FIG. 2, the exothermic catalyst 100 may be prepared by an impregnation process (S400), a drying process (S500) and a heat treatment process (S600).

In the impregnation process (S400), a TiO₂ support is immersed into an aqueous Pt(NH₃)₂(NO₂)₂ precursor solution to support the TiO₂ support with platinum (Pt). In this case, the TiO₂ support may be supported with platinum (Pt) using impregnation. Of course, a catalyst may also be prepared by coprecipitation, ion exchange or the like. However, the catalyst of the present invention can be realized by impregnation which can easily prepare a catalyst because its process is simple. Therefore, it is preferred that the catalyst of the present invention be prepared by impregnation.

The drying process (S500) may be performed at 60˜100° C. for 6˜20 hours after the impregnation process (S400). Most preferably, the TiO₂ support is impregnated with platinum (Pt) by the impregnation process (S400), and then dried at 100° C. for 20 hours by the drying process (S500). If the temperature condition is not satisfied, there may occur the problem of the (NH₃)₂(NO₂)₂ not volatilizing from the aqueous Pt(NH₃)₂(NO₂)₂ precursor solution or the catalytic activity deteriorating. Therefore, it is most preferred that the TiO₂ support that was impregnated with platinum (Pt) be dried at 100° C. for 20 hours.

The heat treatment process (S600) may be performed at 500˜700° C. for 2˜5 hours after the drying process (S500). Particularly, it is most preferred that the heat treatment process (S600) be performed at 700° C. for 5 hours.

The exothermic catalyst 100 is prepared by the above processes, and a stable support, which is made of pure TiO₂ and does not cause a combustion reaction of SOF, is provided as the comparative catalyst 200 in order to calculate the temperature depending on the combustion reaction, thereby calculating the discharge amount of SOF using the temperature difference between the exothermic catalyst 100 causing the combustion reaction of SOF and the comparative catalyst 200.

The measuring unit 300 measures the discharge amount of SOF using a contact combustion type sensor which can convert the temperature difference between the exothermic catalyst 100 and the comparative catalyst 200 into an electrical signal. As such, when the temperature difference between the exothermic catalyst 100 and the comparative catalyst 200 is converted into an electrical signal and the electrical signal is detected, the discharge amount of SOF in exhaust gas can be determined in real time, so that immediate action can be taken in response to the determination.

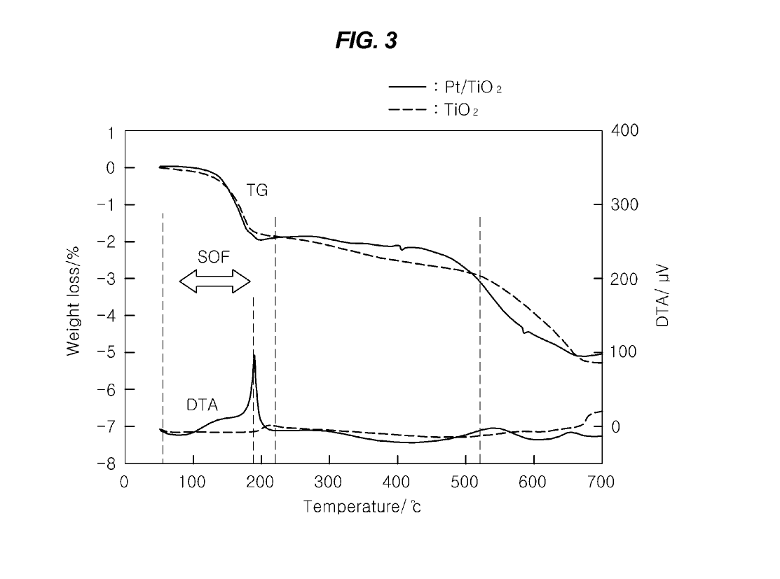

FIG. 3 is a graph showing the discharge amount of SOF measured by using the temperature difference between the exothermic catalyst 100 and comparative catalyst 200 of the sensor for measuring SOF of a diesel engine shown in FIG. 1. This graph shows simulated experiment data of the combustion activity for SOF. In FIG. 3, Pt/TiO₂ is an exothermic catalyst 100, and TiO₂ is a comparative catalyst 200. That is, FIG. 3 shows that, according to the generation of SOF, the temperatures of the exothermic catalyst 100 and the comparative catalyst 200 are changed, thus decreasing the weight of PM.

Specifically explaining the graph of FIG. 3, when the temperatures of the exothermic catalyst 100 and the comparative catalyst 200 are maintained at 100˜200° C., the combustion heat of SOF is generated. Of course, when the temperatures of the exothermic catalyst 100 and the comparative catalyst 200 are further increased to above 200° C., the combustion reaction of SOF actively proceeds, but the effect thereof is insufficient compared to the increase in the temperature. Therefore, it is preferred that the temperatures of the exothermic catalyst 100 and the comparative catalyst 200 be maintained at 100˜200° C. to measure the SOF in the optimum state.

In order to verify the combustion activity of the Pt/TiO₂ exothermic catalyst for SOF, TG (thermogravimetry) and DTA (differential thermal analysis) were used as the experimental methods.

First, the combustion activity of the Pt/TiO₂ exothermic catalyst 100 for SOF is explained using TG (thermogravimetry). Weight loss (%) indicates that weight is reduced by the combustion reaction of the Pt/TiO₂ exothermic catalyst 100 with PM. For example, when the weight ratio of the Pt/TiO₂ exothermic catalyst 100 and PM is 95:5, Pt of the Pt/TiO₂ exothermic catalyst 100 reacts with SOF in PM to generate heat, and thus oxidation and volatilization take place at the same time. Therefore, the weight of SOF is reduced by 2 wt %, and, thereafter, the weight thereof is further reduced by 3 wt % because of the oxidation reaction of soot and other matter in PM.

As shown in FIG. 3, the weight of the Pt/TiO₂ exothermic catalyst 100 is reduced by the combustion reaction of SOF, whereas the weight of SOF is mostly reduced by the volatilization thereof, not by the combustion reaction, because of the characteristics of hydrocarbons.

That is, it can be ascertained from the above experiment that the Pt/TiO₂ exothermic catalyst 100 selectively reacts with SOF.

Meanwhile, the combustion activity of the Pt/TiO₂ exothermic catalyst for SOF is explained using DTA (differential thermal analysis). DTA/μV indicates that, when the temperature is increased by the combustion reaction of the Pt/TiO₂ exothermic catalyst 100 with SOF, the voltage increases depending on the temperature. Specifically, in the Pt/TiO₂ exothermic catalyst 100, combustion heat is generated because the combustion reaction of the Pt/TiO₂ exothermic catalyst 100 with SOF takes place, whereas, in the TiO₂ comparative catalyst 200, combustion heat is not generated because the combustion reaction of the TiO₂ comparative catalyst 200 with SOF does not take place. Therefore, a temperature difference is created between the Pt/TiO₂ exothermic catalyst 100 and the TiO₂ comparative catalyst 200. In this case, when this temperature difference is converted into an electrical signal, the discharge amount of SOF can be calculated depending on the temperature difference therebetween.

That is, as shown in FIG. 3, it can be seen that, since combustion heat is generated by the combustion reaction of the Pt/TiO₂ exothermic catalyst 100 with SOF, when the Pt/TiO₂ exothermic catalyst 100 is used, the voltage rapidly increases compared to when the pure TiO₂ comparative catalyst 200 is used. Therefore, it can be ascertained that the combustion activity of the Pt/TiO₂ exothermic catalyst 100 for SOF is higher than that of the TiO₂ comparative catalyst 200 for SOF.

Based on the above experiment data, a catalyst which has selective activity for SOF can be ascertained, and a catalyst having high combustion activity for SOF and a catalyst having no combustion activity for SOF constitute a sensor, thereby selectively and actively sensing the generation of SOF in the PM of exhaust gas discharged from a diesel engine.

As described above, the sensor for measuring the SOF of a diesel engine according to an exemplary embodiment of the present invention can measure the discharge amount of SOF by applying a catalyst having high combustion activity for SOF in the PM of exhaust gas discharged from a diesel engine.

Specifically, the discharge amount of SOF can be actively sensed using the temperature change and temperature difference between the exothermic catalyst including a material having high combustion activity for SOF and the comparative catalyst including a material having no combustion activity for SOF.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A sensor device for measuring SOF (Soluble Organic Fraction) of a diesel engine, comprising:
an exothermic catalyst including a TiO₂ support impregnated with platinum (Pt) and causing a combustion reaction of the SOF to generate heat;
a comparative catalyst including a TiO₂ support and not causing a combustion reaction of the SOF; and
a measuring unit determining a discharge amount of the SOF using a temperature difference between the exothermic catalyst and the comparative catalyst.

2. The sensor device for measuring the SOF of the diesel engine according to claim 1, wherein, in the exothermic catalyst, the TiO₂ support includes the platinum (Pt) in an amount of between 1 wt % and 7 wt %.

3. The sensor device for measuring the SOF of the diesel engine according to claim 1, wherein the exothermic catalyst is prepared by an impregnation process, a drying process and a heat treatment process.

4. The sensor device for measuring the SOF of the diesel engine according to claim 3, wherein, in the impregnation process, the TiO₂ support in the exothermic catalyst is immersed into an aqueous Pt(NH₃)₂(NO₂)₂ precursor solution to support the TiO₂ support with the platinum (Pt).

5. The sensor device for measuring the SOF of the diesel engine according to claim 4, wherein the drying process is performed at between 60° C. and 100° C. for between 6 hours and 20 hours after the impregnation process.

6. The sensor device for measuring the SOF of the diesel engine according to claim 5, wherein the heat treatment process is performed at between 500° C. and 700° C. for between 2 hours and 5 hours after the drying process.

7. The sensor device for measuring the SOF of the diesel engine according to claim 3, wherein the drying process is performed at between 60° C. and 100° C. for between 6 hours and 20 hours after the impregnation process.

8. The sensor device for measuring the SOF of the diesel engine according to claim 3, wherein the heat treatment process is performed at between 500° C. and 700° C. for between 2 hours and 5 hours after the drying process.
